(19) United States
(12) Patent Application Publication
(10) Pub. No.: US 2022/0335790 A1
(43) Pub. Date: Oct. 20, 2022

(54) SKILL IMPORTANCE FORECASTER FOR A GOLF TOURNAMENT

(71) Applicant: Walter S. Tucker, Somerset, CA (US)

(72) Inventor: Walter S. Tucker, Somerset, CA (US)

(21) Appl. No.: 17/721,263

(22) Filed: Apr. 14, 2022

Related U.S. Application Data
(60) Provisional application No. 63/174,997, filed on Apr. 14, 2021.

(51) Int. Cl. G07F 17/32; G06Q 50/34; A63B 71/06

(52) U.S. Cl. CPC G07F 17/3288; G07F 17/323; G06Q 50/34; A63B 71/0616

(57) ABSTRACT

A method for forecasting skill importance for a golf tournament includes the steps of identifying the golf course where an upcoming golf tournament is to be played; determining that the golf course is the same as the golf course where a prior golf tournament was played; analyzing the results of the previous golf tournament at the golf course to arrive at an initial result of golf skills that are important for a competitor's success at a golf tournament at that golf course; adjusting the initial result based on the strength of the field of competition in the prior golf tournament to arrive at an adjusted result; using the adjusted result to determine the golf skill or golf skills most likely to be a predictor of success at that golf course; comparing the competitors expected to compete in the upcoming golf tournament to identify the competitor or competitors in the upcoming golf tournament that are presently or historically performing relatively well in the determined golf skill or golf skills most likely to be a predictor of success at that golf course; and making a wager, suggesting a wager, or the like, for the upcoming golf tournament on one or more of the identified competitors. Similarly, a player can be identified as performing relatively poorly in the determined golf skill.

### PRIORITY

The present application claims the benefit of domestic priority based on U.S. Provisional Patent Application 63/174,997 filed on Apr. 14, 2021, the entirety of which is incorporated herein by reference.

### BACKGROUND

Sports gambling has always been big business. However, the advent of fantasy sports, daily fantasy sports, and the increasing legality of sports gambling across the United States has pushed the industry to new levels. Many sports gamblers risk their money betting on their favorite team or player, but some sports gamblers are more desirous of reducing their risk and use a more objective analysis for selecting the bets or plays to make. These types of gamblers are constantly in search of a tool that will give them some sort of edge over the house or other competition.

One sport that is growing in popularity as a fantasy and gambling vehicle is golf. Golf tournaments, such as those played on the Professional Golfers' Association (PGA) Tour and related events played by members of the PGA, such as World Golf Championship events, United States Golf Association events, and events on other tours, such as the European Tour. Traditionally, an individual can bet on one or more players in a golf tournament by making traditional wagers, such as by betting on who will win a golf tournament or who will finish the golf tournament in the top predetermined number of finishers, such as the top ten, top twenty, etc. In addition to these traditional wagers, individuals today also have the option of selecting a group of golfers playing in a golf tournament and competing against other individuals who also select a group of golfers. This type of competition, often referred to as daily fantasy sports (DFS) albeit as a misnomer when it comes to golf since a golf tournament generally last several days, can be performed amongst friends or by competing against strangers on a DFS providing service, such as DraftKings or FanDuel or the like. Most often, the group of golfers is selected by the individual by having each golfer in the golf tournament assigned a salary, and then the individual selects a predetermined number of golfers, such as six or seven, making sure to keep the total of the players' salaries below a predetermined salary cap. The individual's group of golfers then accumulate points based on their performance in the golf tournament and the points are compared with other the group of golfers selected by other individuals.

The thing that makes golf different than most other sports when it comes to gambling is that golf events during a golf season are each played on a different course. While all golfers on a professional are proficient at all aspects of the game, each golfer has his or her own relative skill strengths and skill weaknesses. For example, one golfer may be strongest at driving the golf ball off the tee but weaker relative to the other golfers at putting, and vice versa, to name but two of these aspects. Each golf course, by its nature and design, is better suited to certain strengths and/or is more penal to certain weaknesses of a golfer. Accordingly, it is desirable for a gambler to have information for each golf course so the gambler can better predict which golfers are more likely to perform well at a given golf tournament.

Often a golf tournament is played on the same course year after year. While the weather and course set up can vary from one year to another, in general it can be advantageous to look at prior year results in order to make an estimate of what aspects of a golf game will be favored by a particular golf course. There are many tools available to help an individual make these determinations. For example, the PGA Tour publishes the statistics and rankings of all golfers and breaks down the rankings in multiple aspects or skills for the current season and for prior seasons. An individual can look at golfers that were successful at a particular golf course in prior years and can consider the skills those golfers excelled at or when deficient at and this can help the individual form conclusions about the important and less important skills necessary for success at that particular golf course. Sophisticated predictive models exist that generate quantitative results for each golf tournament.

However, existing models and calculations have a significant flaw in their analysis in that they do not accurately account for the strength of the field of competition in a prior golf tournament. For example, some PGA Tour events are scheduled at less ideal times and/or offer lesser prizes and as a result many of the PGA Tour's best players do not compete in those events whereas other events are more desirable for the player and historically have the best golfers in the world competing. Often, when players are ranked, there are a few skills that are consistently high among the top players. Therefore, when a golf tournament is heavily populated by the best golfers in the world, the resulting data coming from current predictive models will tend to skew more towards the skills that the best golfers possess. Similarly, when a golf tournament has fewer top golfers, the predictive results tend to skew away from the skills dominated by the best golfers in the world.

Therefore, there is a need for a skill importance predictor for a golf tournament that analyzes skill importance based on information from a prior golf tournament and that takes into account the strength of field that played in the prior golf tournament.

### SUMMARY

The present invention satisfies these needs. In one aspect of the invention, an improved skill importance forecaster for a golf tournament is provided.

In another aspect of the invention, a skill importance forecaster for a golf tournament analyzes skill importance based on information from a prior golf tournament in an improved manner.

In another aspect of the invention, a skill importance forecaster for a golf tournament analyzes skill importance based on skill information from a prior golf tournament in a manner that reduces factors other than the golf course from skewing the results.

In another aspect of the invention, a skill importance forecaster for a golf tournament analyzes skill importance based on skill information from a prior golf tournament in a manner that is not skewed by the strength of field of the prior golf tournament.

In another aspect of the invention, a skill importance forecaster for a golf tournament analyzes skill importance based on skill information from a prior golf tournament in a manner that adjusts for the strength of field of the prior golf tournament.

In another aspect of the invention, a skill importance forecaster for a golf tournament analyzes skill importance based on skill information from a prior golf tournament wherein the skill information is ranked across multiple golf events.

In another aspect of the invention, a skill importance forecaster for a golf tournament analyzes skill importance based on skill information from a prior golf tournament wherein the skill information is ranked across multiple golf events and normalized for each event.

In another aspect of the invention, a method for forecasting skill importance for a golf tournament comprises identifying the golf course where an upcoming golf tournament is to be played; determining that the golf course is the same as the golf course where a prior golf tournament was played; analyzing the results of the previous golf tournament at the golf course to arrive at an initial result of golf skills that are important for a competitor's success at a golf tournament at that golf course; adjusting the initial result based on the strength of the field of competition in the prior golf tournament to arrive at an adjusted result; and using the adjusted result to determine the golf skill or golf skills most likely to be a predictor of success at that golf course; comparing the competitors expected to compete in the upcoming golf tournament to identify the competitor or competitors in the upcoming golf tournament that are presently or historically performing relatively well in the determined golf skill or golf skills most likely to be a predictor of success at that golf course; making a wager or suggesting a wager for the upcoming golf tournament on one or more of the identified competitors.

In another aspect of the invention, a method for forecasting skill importance for a golf tournament comprises identifying the golf course where an upcoming golf tournament is to be played; determining that the golf course is the same as the golf course where a prior golf tournament was played; analyzing the results of the previous golf tournament at the golf course to arrive at an initial result of golf skills that are important for a competitor's success at a golf tournament at that golf course; adjusting the initial result based on the strength of the field of competition in the prior golf tournament to arrive at an adjusted result; using the adjusted result to determine the golf skill or golf skills most likely to be a predictor of success at that golf course; comparing the competitors expected to compete in the upcoming golf tournament to identify the competitor or competitors in the upcoming golf tournament that are presently or historically performing relatively poorly in the determined golf skill or golf skills most likely to be a predictor of success at that golf course; and making a wager or suggesting a wager for the upcoming golf tournament against one or more of the identified competitors.

### DRAWINGS

These features, aspects, and advantages of the present invention will become better understood with regard to the following description, appended claims, and accompanying drawings which illustrate exemplary features of the invention. However, it is to be understood that each of the features can be used in the invention in general, not merely in the context of the particular drawings, and the invention includes any combination of these features, where:

FIG. 1 is a schematic flow diagram of a skill importance forecaster according to one version of the present invention;

FIG. 2 is a schematic flow diagram of another version of a skill importance forecaster;

FIG. 3 is a schematic flow diagram of another version of a skill importance forecaster;

FIG. 4 is a schematic flow diagram of another version of a skill importance forecaster;

FIG. 5 is a schematic flow diagram of another version of a skill importance forecaster; and

FIG. 6 is a schematic flow diagram of another version of a skill importance forecaster.

### DESCRIPTION

The present invention relates to a skill importance forecaster for a golf tournament. In particular, the invention relates to a skill importance forecaster for a golf tournament that accounts for the strength of field for prior tournaments. Although the skill importance forecaster is illustrated and described in the context of being useful for forecasting a player's success at a golf tournament, the present invention can be useful in other instances. Accordingly, the present invention is not intended to be limited to the examples and embodiments described herein.

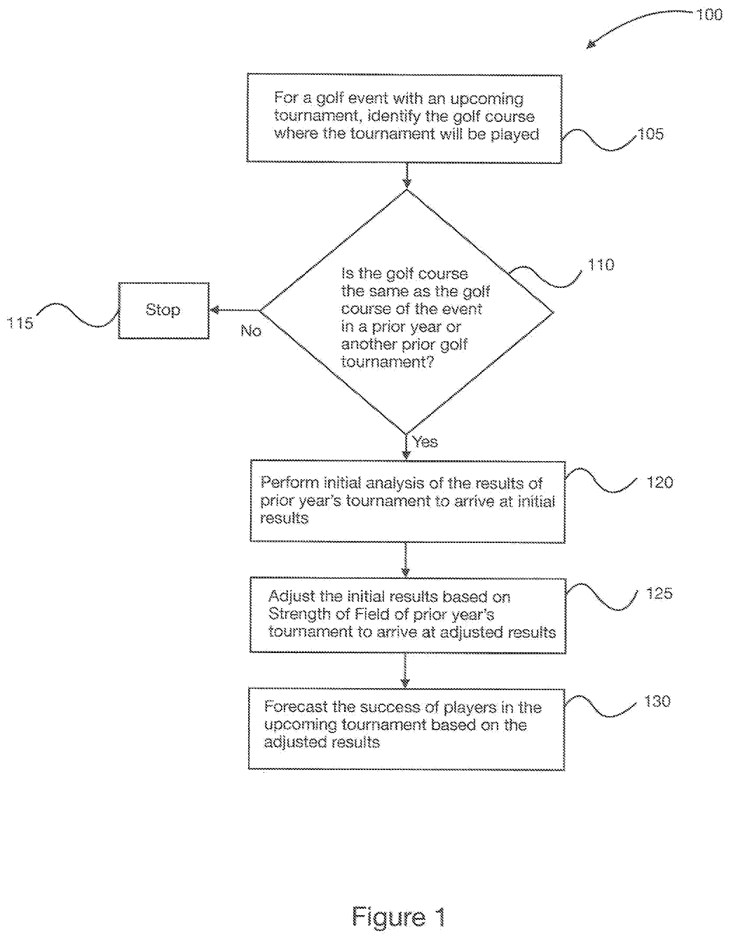

FIG. 1 shows a flow diagram illustrating a skill importance forecaster 100 of the present invention that is useful in helping to determine the golf skill proficiencies that are historically important for success at a particular golf course and thus can help to forecast the success of a player or players in an upcoming golf tournament at the golf course. By golf tournament it is meant any competitive golf tournament where multiple players compete against one another by playing one or more rounds of golf with at least one of the rounds of golf being at a particular golf course. Many golf tournaments are part of an annual, or otherwise periodic, golf event. By golf event it is meant one or more golf tournaments that are played repetitively under a common name, location, sponsor, or the like. For example, the 2021 Masters is a golf tournament played over four rounds in 2021, and the Masters is a golf event that is held annually and is a collection of all Masters tournaments that have been and will be played under that title. Some golf events are held at the same golf course year after year and some events change courses periodically or every year. Some golf tournaments are held at a golf course that has been used in a different golf event.

When an upcoming golf tournament is being played at a golf course that has hosted a prior golf tournament, the results of the prior tournament can be useful in helping to predict the outcome or success of a player or players in the upcoming tournament. For example, a player that won a golf tournament at a particular golf course in a prior year can be expected to perform well at that golf course in future tournaments. However, because golf tournaments have such large fields composed of highly skilled golfers, predicting a winner based on such limited information is often a losing proposition. Instead, it can be more useful to analyze how the design, layout, and/or conditions of the golf course led to the success of players in the prior year and then extrapolate out that information to make a prediction as to which player or players have a better chance of success in the upcoming tournament.

All players have a collection of golfing skills, and most players are better at one or two of the skills than they are at other skills when compared to other players. By skill it is meant an aspect of a player's golf game for which there is a quantitative measurement for the player's proficiency at that skill. Examples of skills include but are not limited to driving, iron play, short game, and putting. For each golf course where a golf tournament is played, the golf course naturally favors proficiency at one or more of the skills and naturally punishes lack of proficiency at one or more of the skills, when compared to other golf tournaments. The degree of favor and/or punishment differs for each course. Accordingly, by determining the skills that are most important and least important for success at a particular golf course, it can be determined if a player's stronger skills and weaker skills relative to other players is a good or bad match for the golf course for an upcoming tournament.

FIG. 1 conceptually shows a method of determining the important skills and/or less important skills indicative of a higher likelihood of success at an upcoming golf tournament. The skill importance forecaster 100 of FIG. 1 begins with identifying 105 the golf course at which an upcoming golf tournament is to be played. The history of the tournament is then searched 110 to determine if a prior golf tournament has been played at that golf course. If no, then the analysis can stop 115 since there is no history of the skills that are useful at that particular golf tournament. If yes, then the results of the prior tournament, such as a prior year's tournament, can be analyzed to determine the important skills associated with that golf course.

The analysis of the prior year's tournament begins by performing an initial analysis 120 of the skills that were of importance and/or lack of importance for success at the prior year's tournament. This initial analysis 120 can involve looking at the top finisher or top finishers and sussing out the important and/or less important skills, as will be discussed. Heretofore predictive models have ended with this analysis. However, the strength of field can skew the results in that the higher ranked golfers in general tend to be relatively better at one or two skills than the lower ranked players. Therefore, with the skill importance forecaster 100 of the present invention, an additional step provides for the adjustment 125 of the initial results based on the strength of field. If no adjustment 125 is made, the results of the analysis can tend to be skewed towards those one or two skills that are consistently high among the higher ranked players when the prior tournament is highly populated by highly ranking players and can tend to be skewed towards other skills when the prior tournament is highly populated by lower ranked players. Examples of ways in which this adjustment can be made are discussed hereinbelow. The adjusted results that come from the adjustment step 125 are a more accurate representation of the skills that have proven to be important and/or less important at a particular course.

Once the important skills are initially analyzed 120 and adjusted 125 the adjusted results can then be used to forecast 130 the success of a player or players in an upcoming tournament at the golf course that was analyzed. For example, if one or two skills are determined to be of importance, the players in the upcoming tournament can be compared to see which player or players are most proficient at those one or two skills. Similarly, if one or two skills are determined to be of little importance for success at a golf course, then the players that are less proficient at those one or two skills can be considered to have a better chance of success at that golf course than at other golf courses that are more punitive to players lacking proficiency in those skills. Thus, by comparing the competitors expected to compete in an upcoming golf tournament, the competitor or competitors in the upcoming golf tournament that are presently or historically performing relatively well in the determined golf skill or golf skills most likely to be a predictor of success at that golf course can be identified. Alternatively or additionally, the competitor or competitors in the upcoming golf tournament that are presently or historically performing relatively poorly in the determined golf skill or golf skills most likely to be a predictor of success at that golf course can be identified.

The identified players can then be used to make a wager or suggest a wager for the upcoming golf tournament. For example, a wager can include a bet on one or more players in a golf tournament by making traditional wagers, such as by betting on who will win a golf tournament or who will finish the golf tournament in the top predetermined number of finishers, such as the top ten, top twenty, etc, or can include a bet on a player to do poorly in the tournament, such as a bet to not win, to not finish in the top predetermined number of finishers, or to not make the cut in the tournament. In addition to these traditional wagers, individuals today also have the option of selecting one or more of the identified players to and to put the one or more players in a group of golfers playing in a golf tournament in a fantasy competition. By suggesting a wager it is meant the encouragement or suggestion to another person to make a wager of the type described. This can be to a friend or acquaintance or by making suggestions to a group of people, such as in a podcast or online tool. Alternatively, the identified players can be used for purposes other than wagering. For example, a golf expert, commentator, and/or writer, can use the information to provide educated analysis.

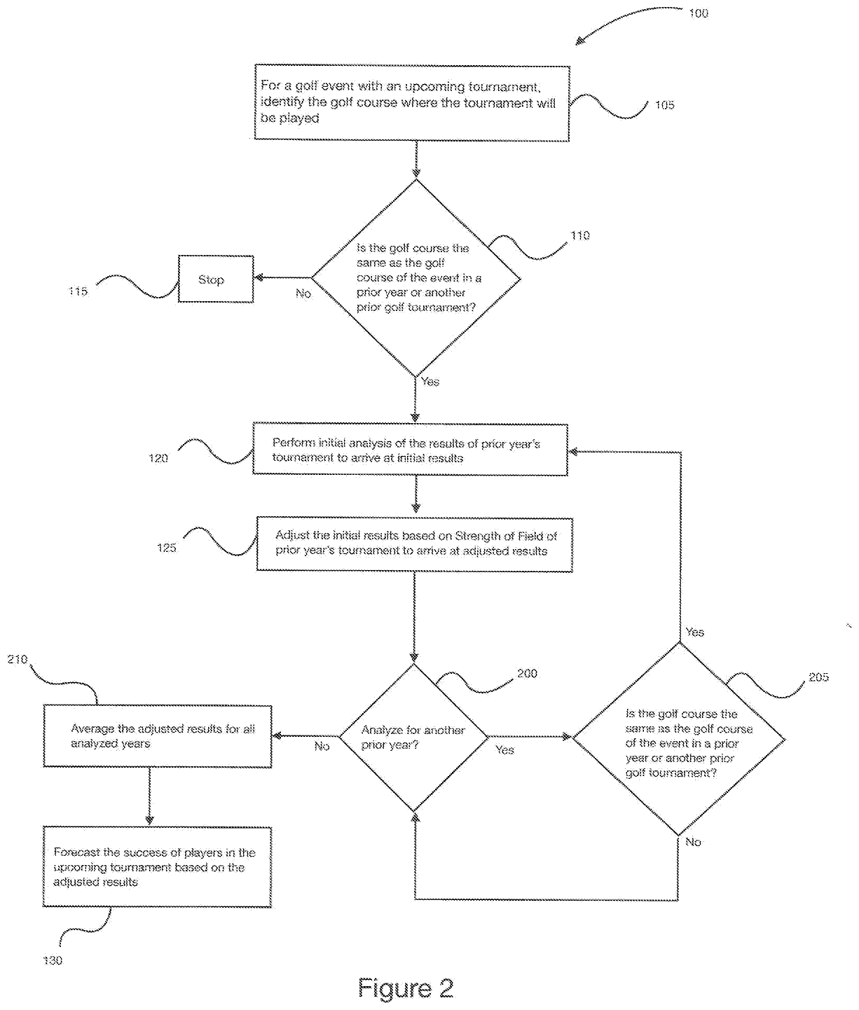

FIG. 2 shows another version of a flow diagram of the skill important forecaster 100 of the invention. The version of FIG. 2 is similar to FIG. 1, but the accuracy of the results are improved by performing the analysis over multiple prior tournaments held at a golf course where an upcoming tournament is to be played. Sometimes only a single tournament has been held at a golf course, and in that case, only that single tournament can be analyzed. Often, though, an event is held at a golf course for several consecutive years. After analyzing a tournament played at a golf course in a prior year, if another year is to be analyzed 200, and if the golf tournament was at the golf course in the other prior year 205, then the analysis 120 and the adjustment 125 is performed again for the other year. Once it has been determined that no more years need to be analyzed, the adjusted results for all of the analyzed years are averaged 210 and the averaged values are used in the forecast 130. Because some small sample size factors, such as weather, unusual set up, luck, and the like can affect the outcome of a single tournament, it may be desirable to use the FIG. 2 version of the skill importance forecaster 100 so the golf course can be analyzed over the course of at least two years or two tournaments. In one version, it is preferable to analyze the results over at least 3 years, and even more preferably to analyze over at least 4 years, when possible. It has been found that analyzing the results over 5 years is particularly preferable in many situations in order to obtain highly accurate results.

In one version, the skills analysis for the skill importance forecaster 100 utilizes quantitative measures of each player's skill in the analysis. For example, the PGA Tour maintains and publishes current and past rankings of players for each of several skills statistics. A player will have a quantitative measure for each skill statistic, and this measure can be a season-long skill statistic that covers an entire prior year or prior season or can be a current-season skill statistic that is an ongoing measure of the player's skill statistic for the current season.

Examples of the skill categories include, but are not limited to, any of the following and any combination of the following. Strokes Gained Off the Tee (SGOTT) is a measure of a players proficiency off of the tee relative to other competitors. When a player performs better on their tee shots than is average, that player will have a positive value for their SGOTT. If a player is worse on their tee shots than is average, that player will have a negative value for their SGOTT. This “strokes gained” tool is used to measure player skill not only off the tee (SGOTT), but also on their approach shots (Strokes Gained Approach SGAPP), their short game around the green (Strokes Gained Around the Green SGARG), and their putting (Stokes Gained Putting SGPUTT). There are even broader strokes gained measures such as Strokes Gained Tee to Green (SGTTG) that combines SGOTT, SGAPP, and SGARG. This SGTTG measure a player's skill from the tee box until they get onto the putting green. While the strokes gained categories give an overall snapshot of a player's proficiency at a certain aspect of the game, there are many more skill statistics that are used to gauge a player's skill in certain areas of their golf game. Along with the SGOTT measure, a player's skill off the tee can be measured by their Driving Distance (DRDIS), Driving Accuracy (DRACC), Good Drive Percentage, or Distance from Edge of Fairway. While SGOTT measures overall how skilled a player is with their drives, additional statistics such as DRDIS, DRACC, Good Drive Percentage, and Distance from Edge of Fairway, make it possible to distinguish skill sets even within the driving category. The same can be said for the approach game. While SGAPP is an overall measure of a players skill approaching the green, it can be beneficial to know more specifically what areas in approaching the green a player excels or lags behind. Statistics that do this include Proximity to the Hole, Approaches from different yardages such as Approaches from 50-125 yards, Approaches from 125-150 yards, Approaches from 150-175 yards, and Approaches from 175-200 yards. These statistics give a measure of a player's skill from specific areas approaching the green whereas SGAPP measures a players overall skill approaching the green. Around the green game can be measured by more than just SGARG, and these additional statistics provide insight to individual players skillsets. These include how skilled a player is out of the bunker, Sand Save Percentage, and how good a player is a saving par whenever they've missed the green, Scrambling. More can be understood about a player's putting skill than the SGPUTT measure. Other important indicators of a players putting skill are their Putts per Round, One-Putt Percentage, and 3-Putt Avoidance Percentage. The before mentioned statistics all measure a players skill in a specific aspect of golf, but it may also be beneficial to know what type of golf holes a player performs best on. In golf, different holes have different pars, generally there are par 3s, par 4s, and par 5s. Different players excel relative to the field on holes with a certain par. Statistics such as Par 3 Scoring Average, Par 3 Performance, Par 4 Scoring Average, Par 4 Performance, Par 5 Scoring Average (PAR5), and Par 5 Performance measure how well a player performs on holes with different pars. As different golf courses have different quantities of par 3s, 4s, and 5s, the knowledge of how a player performs on holes with different pars is important to determining the prediction of outcome for a player at a particular course. Some courses favor a steady golf game with minimal mistakes while some courses reward a bit more risky play and players playing aggressively. Statistics such as Birdie or Better Percentage (BOB), Birdie or Better Ratio, Total Birdies, and Bogey Avoidance all help differentiate scoring tendencies for players. Some courses favor players that can make a lot of birdies while others favor players that are good at avoiding bogeys.

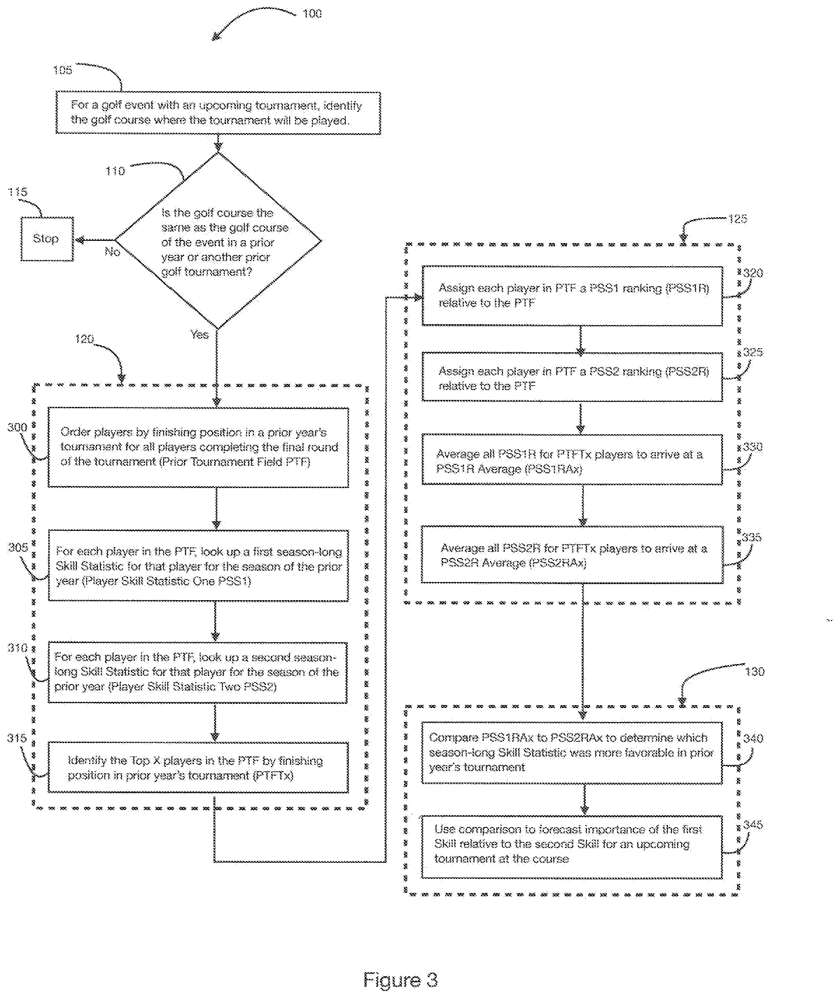

FIG. 3 is a flow chart representing a conceptualized manner in which the published skill statistics can be used to in the skill importance forecaster 100 of the invention. In this version, the step of analyzing 120 the results of a prior year's tournament comprises ordering players by finishing position 300 in the prior year's tournament. In one version, this involves only the players that completed the final round of the tournament and not players that missed a cut, withdrew, or were disqualified or the like. These players that completed the final round can be referred to herein as the Prior Tournament Field (PTF). For each player in the PTF, a first season-long player skill statistic (PSS1) is determined 305. The PSS1 can be, for example, any of the above-mentioned skill categories for the season in which the prior year tournament took place. In similar manner, for each player in the PTF, a second season-long player skill statistic (PSS2) is determined 310. The PSS2 can be any of the above-mentioned skill categories other than PSS1. Additional season-long player skill categories (PSS3, PSS4, etc.) can also optionally be determined. The top players in the prior year tournament are identified 315. In one version, the top players are the top x number of players by order of finish in the tournament, where x can be any number between 1 and the number of players in the PTF. The number x can be selected to be any number of players, provided the number is large enough to give meaningful results but small enough to only include the players that performed well at the tournament. In one version, the number of top players can range from 2 to 20, more preferably from 3 to 18, and more preferably from 5 to 15. It has been determined that in one version the top 10 players provides a particularly preferred result.

In order to account for the strength of field at a prior golf tournament, the results of the initial analysis 120 can then be adjusted 125. One exemplary manner of making this adjustment is shown in FIG. 3. As can be seen, the adjustment 125 for the strength of field first involves for each player in the PTF, assigning each player in the PTF a PSS1 ranking (PSS1R) 320 and a PSS2 ranking (PSS2R) 325. For example, the player with the highest PSS1 may be given a PSS1R of 1, and the second highest a PSS1R of 2, etc. for the entire PTF. Then the PSS1Rs for all players identified as top players in the PTFTx 315 are averaged 330 to arrive at a PSS1R average for the x players (PSS1RAx). Similarly, the PTFTx players' PSS2Rs are averaged 335 to arrive at a PSS2R average for the x players (PSS2RAx). The PSS1RAx and the PSS2RAx are thus an output of the skill importance forecaster 100 that makes up the adjusted result.

The adjusted result, which in the case of the version of FIG. 3 is the PSS1RAx and the PSS2RAx, can then be used to forecast the success of players 130 in an upcoming tournament at the analyzed course. As shown in FIG. 3, the forecast 130 can comprise comparing 340 the PSS1RAx to the PSS2RAx to determine which skill is relatively more important for that course. With this information, a user can then use the information 345 to forecast the success of players in the upcoming tournament. For example, if PSS1 is found to be significantly more important than PSS2, players that excel at PSS1 during the current season, or an immediately prior season if the current season is not sufficiently long to have meaningful results, can be identified as players to target or bet on for the upcoming tournament over players that are not as proficient at PSS1. By performing the analysis for several skill categories, a relative importance of all analyzed skill categories can be determined.

The result of the analysis 120 of the PSS1 and the PSS2 without the adjustment performed in step 125 can in some circumstances provide useful information. However, this is not always the case, especially for tournaments heavily populated by either highly skilled players or heavily populated by lower skilled players. To illustrate, consider the following hypothetical and highly simplified result for a prior year 6-player tournament that is highly populated by highly ranked players, and with x=2:

| Finish | PSS1 | PSS2 | | |
|---|---|---|---|---|
| Position | (Driving) | (Short Game) | PSS1x | PSS2x |
| 1 | 44 | 75 | 44 | 75 |
| 2 | 23 | 61 | 23 | 61 |
| 3 | 9 | 112 | | |
| 4 | 17 | 98 | | |
| 5 | 39 | 28 | | |
| 6 | 17 | 82 | | |
| AVGx | | | 33.5 | 68 |

In this example, a hypothetic driving index is selected as PSS1 and a hypothetical short game index is selected for PSS2. The numbers shown in the second and third columns are the respective season-long rankings for the associated player for their tour in the season of the prior tournament. Note that in the format shown, the rankings are made with the lower number being better, but they could be performed with a higher number representing a better ranking. When we a then analyze the top 2 players from the tournament, the driving skills average to 33.5 and the short game skills average to 68. Viewing this data alone, it would tend to indicate that driving is a more important factor than short game for this golf course since the average tour ranking is lower for driving than the average tour ranking for short game. Now, the following chart illustrates the same hypothetical but with the strength of field adjustment step 125 performed:

| | | PSS2 | | | | |
|---|---|---|---|---|---|---|
| Finish | PSS1 | (Short | | | | |
| Position | (Driving) | Game) | PSS1R | PSS2R | PSS1Rx | PSS2Rx |
| 1 | 44 | 75 | 6 | 3 | 6 | 3 |
| 2 | 23 | 61 | 4 | 2 | 4 | 2 |
| 3 | 9 | 112 | 1 | 6 | | |
| 4 | 17 | 98 | 2 | 5 | | |
| 5 | 39 | 28 | 5 | 1 | | |
| 6 | 18 | 82 | 3 | 4 | | |
| AVGx | | | | | 5 | 2.5 |

With the adjustment being made for strength of field, it can be seen that PSS2 is the more important skill for this course as PSS2Rx has a better (i.e. lower in this set up) ranking average than PSS1Rx.

A similarly skewed result can be obtained from the analysis of a tournament with a weak field if the adjustment 125 is not performed. For example, consider the following hypothetical and highly simplified result for a prior year 6-player tournament that is highly populated by lower ranked players, and with x=2:

| Finish | PSS1 | PSS2 | | |
|---|---|---|---|---|
| Position | (Driving) | (Short Game) | PSS1x | PSS2x |
| 1 | 86 | 97 | 86 | 97 |
| 2 | 64 | 38 | 64 | 38 |
| 3 | 124 | 94 | | |
| 4 | 77 | 75 | | |
| 5 | 95 | 41 | | |
| 6 | 104 | 85 | | |
| AVGx | | | 75 | 67.5 |

With this weaker field, it may appear from the unadjusted analysis that PSS2 is slightly more important than PSS1. However, as the following chart with the adjustment 125 illustrates, it may actually be PSS1 that is more important after the adjustment 125 is made:

| | | PSS2 | | | | |
|---|---|---|---|---|---|---|
| Finish | PSS1 | (Short | | | | |
| Position | (Driving) | Game) | PSS1R | PSS2R | PSS1Rx | PSS2Rx |
| 1 | 86 | 97 | 3 | 6 | 3 | 6 |
| 2 | 64 | 38 | 1 | 1 | 1 | 1 |
| 3 | 124 | 94 | 6 | 5 | | |
| 4 | 77 | 75 | 2 | 3 | | |
| 5 | 95 | 41 | 4 | 2 | | |
| 6 | 104 | 85 | 5 | 4 | | |
| AVGx | | | | | 2 | 3.5 |

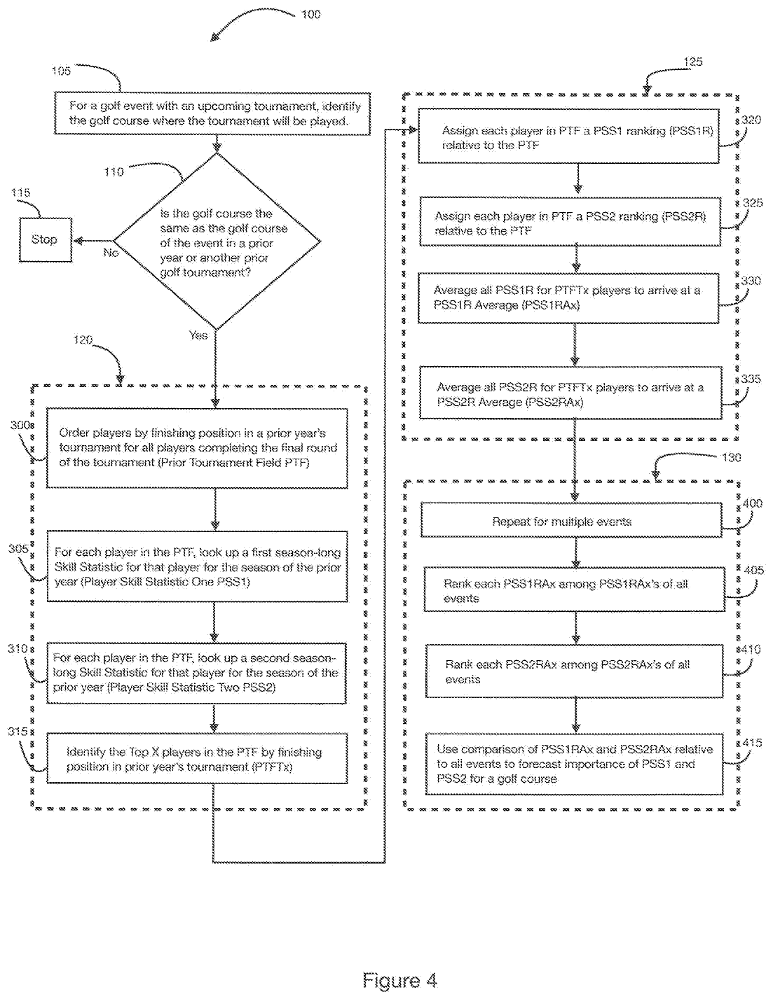

In another version of the skill importance forecaster 100, as shown in FIG. 4, the focasting step 130 can be further improved by taking the adjusted results from step 125 and ranking each skill analyzed over multiple events. In this version, the forecast step 130 involves repeating the analysis 400 for at least one additional event. More preferably, the analysis can be repeated for at least three events, more preferably for at least five events, more preferably for at least ten events, and most preferably for all events in a golf season where an event is played at the same course in consecutive seasons. For each event analyzed, the PSS1RAx is ranked 405. For example, for all of the events analyzed, the event where the PSS1RAx is determined to be the most important, such as by having the lowest quantitative value when a system such as the one hypothetically illustrated above is used, can be assigned a rank of 1, and the event where it is the second most important can be assigned a value of 2, etc. The same ranking can then be performed for PSS2RAx 410 and for all other PSS's that are analyzed. All of the rankings can then be compared 415 to forecast the relative importance of the skills across several events.

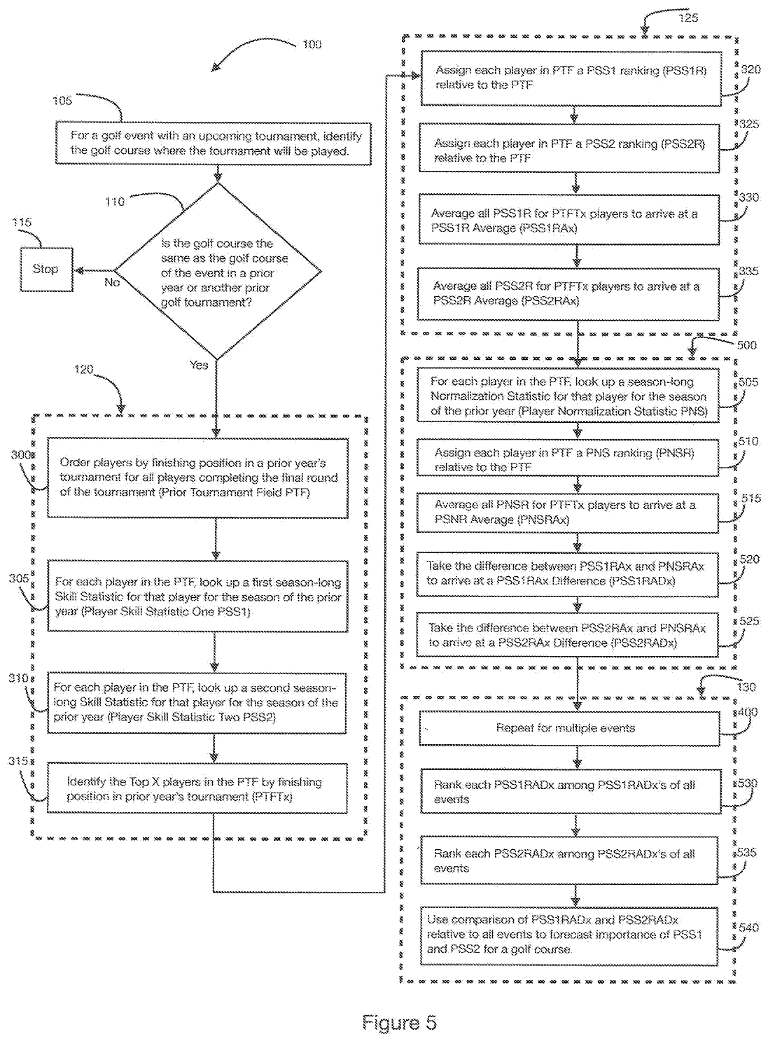

Another version of the skill importance forecaster 100 is shown in FIG. 5. This version is similar to FIG. 4 but includes an additional normalization process 500 that further helps to account for variability between events that are from factors other than skill importance and/or to help normalize the values so all are roughly on a similar scale. The normalization process 500 can thus help correct for variations in event to event values that result from things such as course difficulty and field makeup. To perform the normalization process 500 of the version of FIG. 5, for each player in the PTF, a player's season-long normalization statistic (PNS) is looked up 505 for that player for the year or season of the prior tournament. Each player in the PTF is then assigned 510 a PNS ranking (PNSR) relative to the rest of the PTF. All PNSR's are averaged 515 for the top players, such as the PTFTx from step 315, to arrive at an average PNSR (PNSRAx). The difference between the PSS1RAx and the PNSRAx is then determined 520 to arrive at a PSS1RAx difference (PSS1RADx) and the same is performed for PSS2RAx to arrive at a PSS2RADx. Then, in the forecasting step 130, steps 530, 535, and 540 and the same as steps 405, 410, and 415, respectively, of FIG. 4 but with PSS1RADx substituted for PSS1RAx and PSS2RADx substituted for PSS2RAx.

The player normalization statistic (PNS) used in the normalization process 500 in the version of FIG. 5 can be any season-long statistic that is an overall quantitative assessment of a player's abilities for that year. The PNS selected can be one or more of any of the following of any other statistic that is similarly situated. There are some statistical measures that represent how skilled a golfer is as a whole. One such measure is Strokes Gained Total (SGTOT). SGTOT is a combination of the SGOTT, SGAPP, SGARG, and SGPUTT statistics and measures how a golfer's total game compares to other players. Another possible normalization statistic is a player's Scoring Average. This is the average of how many strokes it takes a player to complete a round of golf. The better the player's scoring average the more skilled that golfer is as a whole. How skilled a golfer is as a whole can also be measured by how much prize money a player has made throughout the season. As the top prize money increases the closer a player is to the top of the leaderboard, the best players make more money than the inferior players. Measuring how much money a player has made throughout a season is a valid way to measure how skilled a golfer is. Many tours have year-long Standings where players accumulate points based off of how well they performed throughout the season. As more points are rewarded to players who have better finishing positions, Standing such as this are a measure of overall golfer skill. An example of a system like this is the FedEx Cup standing on the PGA Tour. Tournaments on the PGA Tour have FedEx Cup points available and more points are rewarded to a player the better they place in the tournament. These points accumulate throughout the season, meaning the best performing players for that season earn the most points. Alternatively or additionally, the Official World Golf Rankings (OWGR) uses past tournament results to rank golfers by skill. The OWGR aims to rank the most skilled player in the world first and a lower ranking is representative of a less skilled golfer. Using the OWGR is another way to measure a golfers overall skill.

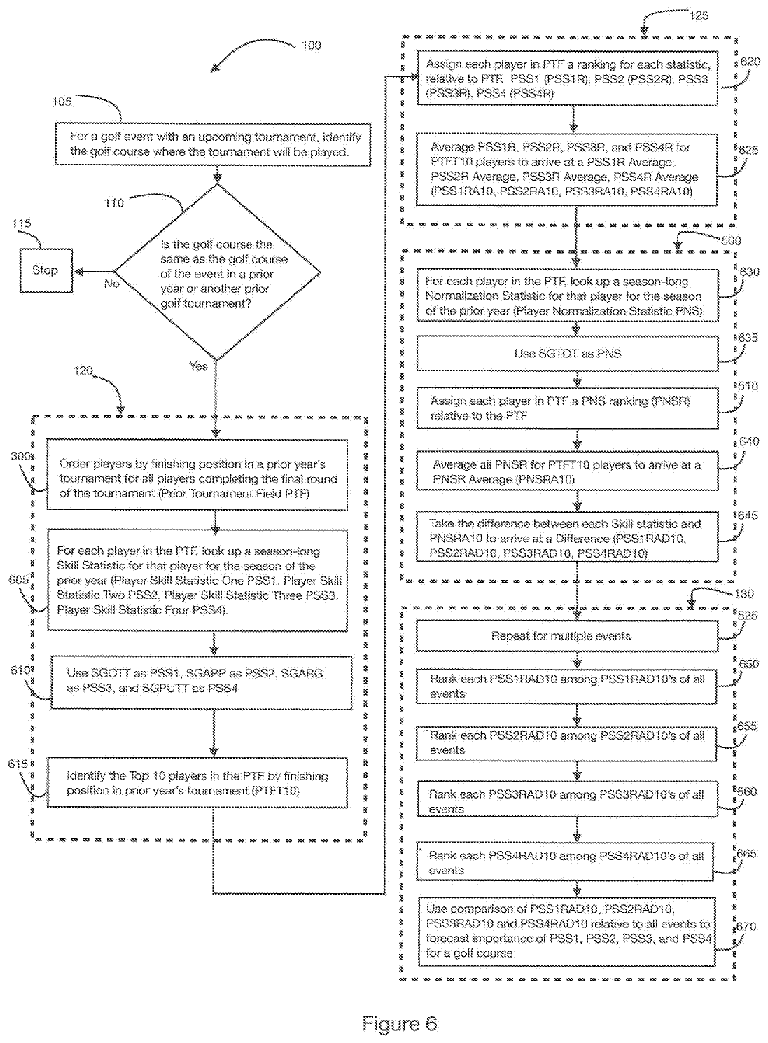

A particular version of a skill importance forecaster 100 is shown in FIG. 6. The version of FIG. 6 incorporates many of the features previously discussed into a single model. In this version, four specific skills are exemplified for use PSS1, PSS2, PSS3, and PSS4. However, fewer, more, or different skills can be used instead. In one particular version, one or more of SGOTT, SGAPP, SGARG, SGPUTT, DRDIS, DRACC, PAR5, and BOB are used, and in one particularly preferred version, all eight are used. In the example of FIG. 6, x is selected as 10, but that number can be different, as discussed above.

Although the present invention has been described in considerable detail with regard to certain preferred versions thereof, other versions are possible, and alterations, permutations and equivalents of the version shown will become apparent to those skilled in the art upon a reading of the specification and study of the drawings. For example, the cooperating components may be reversed or provided in additional or fewer number, and all directional limitations, such as up and down and the like, can be switched, reversed, or changed as long as doing so is not prohibited by the language herein with regard to a particular version of the invention. Also, the various features of the versions herein can be combined in various ways to provide additional versions of the present invention. Furthermore, certain terminology has been used for the purposes of descriptive clarity, and not to limit the present invention. Throughout this specification and any claims appended hereto, unless the context makes it clear otherwise, the term “comprise” and its variations such as “comprises” and “comprising” should be understood to imply the inclusion of a stated element, limitation, or step but not the exclusion of any other elements, limitations, or steps. Throughout this specification and any claims appended hereto, unless the context makes it clear otherwise, the term “consisting of” and “consisting essentially of” and their variations such as “consists” should be understood to imply the inclusion of a stated element, limitation, or step and not the exclusion of any other elements, limitations, or steps or any other non-essential elements, limitations, or steps, respectively. Throughout the specification, any discussed on a combination of elements, limitations, or steps should be understood to include a disclosure of additional elements, limitations, or steps and the disclosure of the exclusion of additional elements, limitations, or steps. All numerical values, unless otherwise made clear in the disclosure or prosecution, include either the exact value or approximations in the vicinity of the stated numerical values, such as for example about +/− ten percent or as would be recognized by a person or ordinary skill in the art in the disclosed context. The same is true for the use of the terms such as about, substantially, and the like. Also, for any numerical ranges given, unless otherwise made clear in the disclosure, during prosecution, or by being explicitly set forth in a claim, the ranges include either the exact range or approximations in the vicinity of the values at one or both of the ends of the range. When multiple ranges are provided, the disclosed ranges are intended to include any combinations of ends of the ranges with one another and including zero and infinity as possible ends of the ranges. Therefore, any appended or later filed claims should not be limited to the description of the preferred versions contained herein and should include all such alterations, permutations, and equivalents as fall within the true spirit and scope of the present invention.

What is claimed is:

1. A method for forecasting skill importance for a golf tournament, the method comprising:
identifying the golf course where an upcoming golf tournament is to be played;
determining that the golf course is the same as the golf course where a prior golf tournament was played;
analyzing the results of the previous golf tournament at the golf course to arrive at an initial result of golf skills that are important for a competitor's success at a golf tournament at that golf course;
adjusting the initial result based on the strength of the field of competition in the prior golf tournament to arrive at an adjusted result;
using the adjusted result to determine the golf skill or golf skills most likely to be a predictor of success at that golf course;
comparing the competitors expected to compete in the upcoming golf tournament to identify the competitor or competitors in the upcoming golf tournament that are presently or historically performing relatively well in the determined golf skill or golf skills most likely to be a predictor of success at that golf course; and
making a wager or suggesting a wager for the upcoming golf tournament on one or more of the identified competitors.

2. A method according to claim 1 wherein the wager is a bet on the one or more identified competitors to win the upcoming golf tournament.

3. A method according to claim 1 wherein the wager is a bet on the one or more identified competitors to finish the upcoming golf tournament in top predetermined number of finishers.

4. A method according to claim 1 wherein the wager is the creation and submission of a fantasy team that includes the one or more identified competitors.

5. A method according to claim 1 wherein the step of determining that the golf course is the same as the golf course where a prior golf tournament was played further comprises determining that at least three prior golf tournaments were played at the golf course.

6. A method according to claim 1 wherein the step of analyzing the results of the previous golf tournament at the golf course to arrive at an initial result of golf skills that are important for a competitor's success at a golf tournament at that golf course comprises:
ordering players by finishing position in a prior year's tournament;
for each ordered player, looking up a first season-long skill statistic for season of prior year's golf tournament;
for each ordered player, looking up a second season-long skill statistic for season of prior year's golf tournament; and
identifying the top players by finishing position in the prior year's golf tournament.

7. A method according to claim 6 wherein the step of adjusting the initial result based on the strength of the field of competition in the prior golf tournament to arrive at an adjusted result comprises:
for each ordered player, ranking each ordered player by first season-long skill statistic;
for each ordered player, ranking each ordered player by second season-long skill statistic;
averaging the first season-long skill statistic for all top players by finishing position in prior year's golf tournament; and
averaging the second second-long skill statistic for all top players by finishing position in prior year's golf tournament.

8. A method according to claim 7 wherein the step of using the adjusted result to determine the golf skill or golf skills most likely to be a predictor of success at that golf course comprises:
comparing the average of the first season-long skill statistic for all top players with the average of the second season-long skill statistic for all top players, and
using the comparison to determine which of the first season-long skill statistic and the second season-long skill statistic is relatively more important.

9. A method according to claim 8 wherein the step of comparing the competitors expected to compete in the upcoming golf tournament to identify the competitor or competitors in the upcoming golf tournament that are presently performing relatively well in the determined golf skill or golf skills most likely to be a predictor of success at that golf tournament comprises:
for a first competitor in the upcoming golf tournament, looking up the first competitor's current rank in the skill statistic determined to be relatively more important;
for a second competitor in the upcoming golf tournament, looking up the second competitor's current rank in the skill statistic determined to be relatively more important; and
comparing the first competitor's and the second competitor's current rank in the skill statistic determined to be relatively more important to determine the player more likely to do well in the upcoming golf tournament.

10. A method according to claim 9 wherein the first competitor's current rank relates to the first competitor's current performance in the skill statistic over a predetermined period.

11. A method according to claim 10 wherein the predetermined period is selected from the group consisting of the current season, the preceding season, the preceding predetermined number of rounds or tournaments, and a predetermined recent period of time.

12. A method according to claim 6 wherein the first second-long skill statistic and the second season-long skill statistic are different statistics selected from the group consisting of Strokes Gained Off the Tee, Strokes Gained Approach, Strokes Gained Around the Green, Stokes Gained Putting, Strokes Gained Tee to Green, Driving Distance, Driving Accuracy, Good Drive Percentage, Distance from Edge of Fairway, Proximity to the Hole, Approaches from different yardages, Sand Save Percentage, Scrambling, Putts per Round, One-Putt Percentage, 3-Putt Avoidance Percentage, Par 3 Scoring Average, Par 3 Performance, Par 4 Scoring Average, Par 4 Performance, Par 5 Scoring Average, Par 5 Performance, Birdie or Better Percentage, Birdie or Better Ratio, Total Birdies, and Bogey Avoidance.

13. A method for forecasting skill importance for a golf tournament, the method comprising:
identifying the golf course where an upcoming golf tournament is to be played;
determining that the golf course is the same as the golf course where a prior golf tournament was played;
analyzing the results of the previous golf tournament at the golf course to arrive at an initial result of golf skills that are important for a competitor's success at a golf tournament at that golf course;
adjusting the initial result based on the strength of the field of competition in the prior golf tournament to arrive at an adjusted result;
using the adjusted result to determine the golf skill or golf skills most likely to be a predictor of success at that golf course;
comparing the competitors expected to compete in the upcoming golf tournament to identify the competitor or competitors in the upcoming golf tournament that are presently or historically performing relatively poorly in the determined golf skill or golf skills most likely to be a predictor of success at that golf course; and
making a wager or suggesting a wager for the upcoming golf tournament against one or more of the identified competitors.

14. A method according to claim 13 wherein the wager is a bet on the one or more identified competitors to perform poorly in the upcoming golf tournament or a bet on another competitor to do better than the one or more identified competitors.

15. A method according to claim 13 wherein the wager is a bet on the one or more identified competitors to not make the cut in the upcoming golf tournament.

16. A method according to claim 13 wherein the wager is the creation and submission of a fantasy team that avoids the one or more identified players.

17. A method according to claim 13 wherein the step of analyzing the results of the previous golf tournament at the golf course to arrive at an initial result of golf skills that are important for a competitor's success at a golf tournament at that golf course comprises:
ordering players by finishing position in a prior year's tournament;
for each ordered player, looking up a first season-long skill statistic for season of prior year's golf tournament;
for each ordered player, looking up a second season-long skill statistic for season of prior year's golf tournament; and
identifying the top players by finishing position in the prior year's golf tournament, and
wherein the step of adjusting the initial result based on the strength of the field of competition in the prior golf tournament to arrive at an adjusted result comprises:
for each ordered player, ranking each ordered player by first season-long skill statistic;
for each ordered player, ranking each ordered player by second season-long skill statistic;
averaging the first season-long skill statistic for all top players by finishing position in prior year's golf tournament; and
averaging the second second-long skill statistic for all top players by finishing position in prior year's golf tournament, and
wherein the step of using the adjusted result to determine the golf skill or golf skills most likely to be a predictor of success at that golf course comprises:
comparing the average of the first season-long skill statistic for all top players with the average of the second season-long skill statistic for all top players, and
using the comparison to determine which of the first season-long skill statistic and the second season-long skill statistic is relatively more important, and
wherein the step of comparing the competitors expected to compete in the upcoming golf tournament to identify the competitor or competitors in the upcoming golf tournament that are presently performing relatively poorly in the determined golf skill or golf skills most likely to be a predictor of success at that golf tournament comprises:
for a first competitor in the upcoming golf tournament, looking up the first competitor's current rank in the skill statistic determined to be relatively more important;
for a second competitor in the upcoming golf tournament, looking up the second competitor's current rank in the skill statistic determined to be relatively more important; and
comparing the first competitor's and the second competitor's current rank in the skill statistic determined to be relatively more important to determine the player more likely to do poorly in the upcoming golf tournament.

18. A method for forecasting skill importance for a golf tournament, the method comprising:
identifying the golf course where an upcoming golf tournament is to be played;
determining that the golf course is the same as the golf course where a prior golf tournament was played;
analyzing the results of the previous golf tournament at the golf course to arrive at an initial result of golf skills that are important for a competitor's success at a golf tournament at that golf course;
adjusting the initial result based on the strength of the field of competition in the prior golf tournament to arrive at an adjusted result; and
using the adjusted result to determine the golf skill or golf skills most likely to be a predictor of success at that golf course;
comparing the competitors expected to compete in the upcoming golf tournament to identify the competitor or competitors in the upcoming golf tournament that are presently or historically performing relatively well in the determined golf skill or golf skills most likely to be a predictor of success at that golf course;
using the identified players in performing expert analysis or commentary about the upcoming golf tournament.
